(19) United States
(12) Patent Application Publication
(10) Pub. No.: US 2009/0278523 A1
(43) Pub. Date: Nov. 12, 2009

(54) NON-CONTACT POWER TRANSMISSION DEVICE, POWER TRANSMISSION DEVICE AND ELECTRONIC APPARATUS USING THE SAME

(75) Inventors: Kentaro YODA, Chino-shi (JP); Hirofumi OKADA, Suwa-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/434,370

(22) Filed: May 1, 2009

(30) Foreign Application Priority Data
May 8, 2008 (JP) 2008-122270

(51) Int. Cl. H02J 17/00

(52) U.S. Cl. 323/318; 323/328; 307/104

(57) ABSTRACT

A non-contact power transmission device for supplying electric power to a secondary coil from a primary coil by electromagnetically coupling the primary coil to the secondary coil, includes a temperature detection element that detects temperature and a detection section that detects rise of temperature based on a first temperature at a first clock time and a second temperature at a second clock time detected by using the temperature detection element. When a degree of the rise of temperature is greater than a reference value, the non-contact power transmission device stops supplying of the electric power from the primary coil.

This application claims priority to Japanese Patent Application No. 2008-122270 filed in Japan on May 8, 2008, the entire disclosure of which is hereby incorporated by reference in its entirety.

### BACKGROUND

1. Technical Field

The present invention relates to a non-contact power transmission device suitable for transmission of electric power in a non-contact manner, a power transmission device and an electronic apparatus using the same.

2. Related Art

A non-contact power transmission technique is known that enables electric power to be transmitted by utilizing electromagnetic induction without a metallic contact. As an application of the above non-contact power transmission technique, a technique of charging a mobile phone or a home-house device (for example, a cordless handset for a telephone) has been heretofore offered.

JP-A-2006-60909 is an example of related art. In the description, a series resonance circuit is configured of a resonance capacitor and a primary coil connected to an output terminal of a power transmission driver, and power is supplied to a power reception device (secondary side) from a power transmission device (primary side).

In recent years, it has been more and more demanded to miniaturize a mobile phone. With the above circumstances, decreasing of a coil unit for electric power transmission in size, particularly, in thickness is more required.

In, for example, a non-contact power transmission system, when a foreign object such as a metallic material is interposed between a primary coil and a coil, an eddy current is generated on the foreign object, thereby generating heat.

### SUMMARY

An advantage of the present invention is to provide a power transmission device capable of detecting abnormal heat due to entering of a foreign object, and an electronic apparatus using the same.

According to a first aspect of the invention, a power transmission device having a primary coil capable of supplying electric power to a load of a power reception device by electromagnetically coupling the primary coil with a secondary coil of the power reception device, includes a power transmission section that supplies an alternating current (AC) signal to the primary coil, a temperature detection element provided to a magnetic flux forming region of the primary coil, an abnormal temperature rise detection section that detects abnormal rise of temperature based on first temperature at a first clock time and second temperature at a second clock time detected by the temperature detection element, and a power transmission control section that controls the power transmission section and allows it to stop transmission of electric power from the primary coil when the abnormal temperature rise detection section detects abnormal rise of temperature.

In the first aspect of the invention, when a foreign object exists in the magnetic flux forming region of the primary coil, the transmission of electric power can be stopped by detecting abnormal heat due to an eddy current generated on the foreign object. In order to detect the abnormal heat, the temperature detection element is provided to the magnetic flux forming region of the primary coil. In addition, in order to determine the abnormal head, absolute temperature is not determined but the abnormal rise of temperature is determined. The abnormal rise of temperature can be detected based on the first temperature and the second temperature detected by the temperature detection element.

In the first aspect of the invention, the temperature detection element may be a variable resistance element whose resistance value is varied in accordance with temperature. As a typical example of the above described variable resistance element, a thermistor can be listed.

In the first aspect of the invention, the abnormal temperature rise detection section can detect the abnormal rise of temperature based on the first voltage at the first clock time and the second voltage at the second clock time which are varied by the variable resistance element. Since the voltage is varied by variation of the resistance value of the variable resistance element, the variation of the voltage between the first clock time and the second clock time indicates a degree of the rise of temperature.

In the first aspect of the invention, the abnormal temperature rise detection section may include a resistance-frequency conversion circuit that converts a variable resistance value of the variable resistance element to a frequency. The abnormal temperature rise detection section can detect the abnormal rise of temperature based on a result obtained by comparing a first frequency at the first clock time with a second frequency at the second clock time, the frequencies being varied by the variable resistance value. When, for example, an RC circuit is configured of the variable resistance element having the variable resistance value and a capacitor, it is possible to form the resistance-frequency conversion circuit capable of converting variation of resistance to variation of frequency. As the frequency can be varied in accordance with the variation of the resistance value of the variable resistance element, the difference in frequency between the first clock time and the second clock time indicates the degree of the rise of temperature.

In the first aspect of the invention, the abnormal temperature rise detection section may include a comparator that compares a differential result between the first temperature and the second temperature detected by the temperature detection element with a reference value, and the reference value can be adjusted. Since the rise of temperature at the magnetic flux forming region of the primary coil obtained as the above described also appears in a normal condition that a foreign object does not exist, the differential result is compared with the reference value by the comparator in order to discriminate between the normal and abnormal conditions. However, the rise of temperature at the magnetic flux forming region of the primary coil is varied by an environment where the primary coil is provided. The environment includes a heat radiating environment such as, for example, a material, a thickness, or a shape of a housing accommodating the primary coil, or a distance between the primary coil and the housing. Therefore, the reference value should be adjusted by each product, and it is preferable to adjust the reference value, for example, at the time of shipping from a factory.

In the first aspect of the invention, the primary coil is an air core coil having an air core part. The temperature detection element can be provided to the air core part. It is because that the magnetic flux density at the air core part is particularly large. When a foreign object enters the air core part, the rising of temperature is markedly rapid due to an eddy current generated on the foreign object, and then heating is enhanced.

According to a second aspect of the invention, an electronic apparatus such as a charging device includes the above described power transmission device.

### BRIEF DESCRIPTION OF THE DRAWINGS

The invention will be described with reference to the accompanying drawings, wherein like numbers reference like elements.

FIG. 1 is a schematic view typically illustrating a charging device and an electronic apparatus such as a mobile phone to be charged by the charging device;

FIG. 2 is a schematic view illustrating an exemplary structure of a non- contact power transmission system;

FIG. 3 is an exploded perspective view typically illustrating a primary coil unit;

FIG. 4 is a schematic perspective view illustrating a transmission device in which the primary coil unit and a control unit are electrically connected to each other;

FIG. 5 is a schematic block diagram illustrating the control unit shown in FIG. 4;

FIG. 6 is a block diagram showing one exemplary structure of an abnormal temperature rise detection section shown in FIG. 5;

FIG. 7 is a characteristic graph showing a rising curve of temperature detected by a thermistor from start of transmission of electric power;

FIG. 8 is a block diagram showing another exemplary structure of the abnormal temperature rise detection section shown in FIG. 5;

FIG. 9 is a characteristic graph showing an output signal of an x(F converter shown in FIG. 8; and

FIG. 10 is a schematic perspective view illustrating a different type of coil unit.

### DETAILED DESCRIPTION OF EMBODIMENTS

Embodiments of the invention will be explained with reference to the accompanying drawings.

It should be noted that embodiments described below do not limit the spirit or scope of the invention defined by the appended claims and all the structures in the embodiments described below are not necessarily needed to form the solution of the invention.

### 1. Charging System

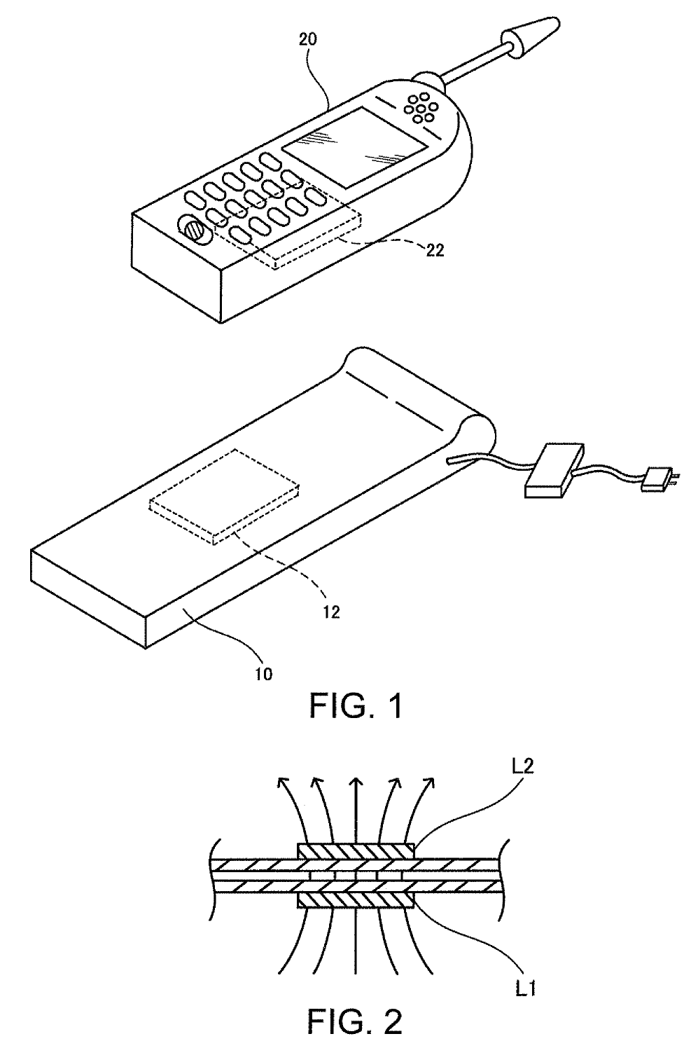

FIG. 1 is a schematic view typically illustrating a charging device 10 as an embodiment of electronic apparatuses and another electronic apparatus such as, for example, a mobile phone 20 which is charged by the charging device 10. FIG. 1 shows the mobile phone 20 transversely placed on the charging device 10. The charging of the mobile phone 20 from the charging device 10 is carried out by a non-contact power transmission system using an electromagnetic induction action between a coil of a coil unit 12 in the charging device 10 and a coil of a coil unit 22 in the mobile phone 20.

Each of the charging device 10 and the mobile phone 20 may have a positioning structure. For example, the charging device 10 may be provided with a positioning projection protruding to an outside from an outer surface of its housing, and the mobile phone 20 may be provided with a positioning recess formed on an outer surface of its housing. With the above positioning structures, the coil unit 22 of the mobile phone 20 is placed on at least a position facing the coil unit 12 of the charging device 10.

As typically shown in FIG. 2, the transmission of electric power to the mobile phone 20 from the charging device 10 is achieved such that a primary coil L1 (power transmission coil) provided to the charging device 10 and a secondary coil L2 (power reception coil) provided to the mobile phone 20 are electromagnetically coupled with each other to form a power transmission transformer. With the above configuration, the transmission of electric power in a non-contact manner can be carried out. Note that, while FIG. 2 shows an exemplary configuration of the electromagnetic coupling between primary and secondary coils L1 and L2, it is possible to take another configuration whose formation of magnetic fluxes can be different from that in FIG. 2.

### 2. Coil Unit of Charging Device (At Primary Side)

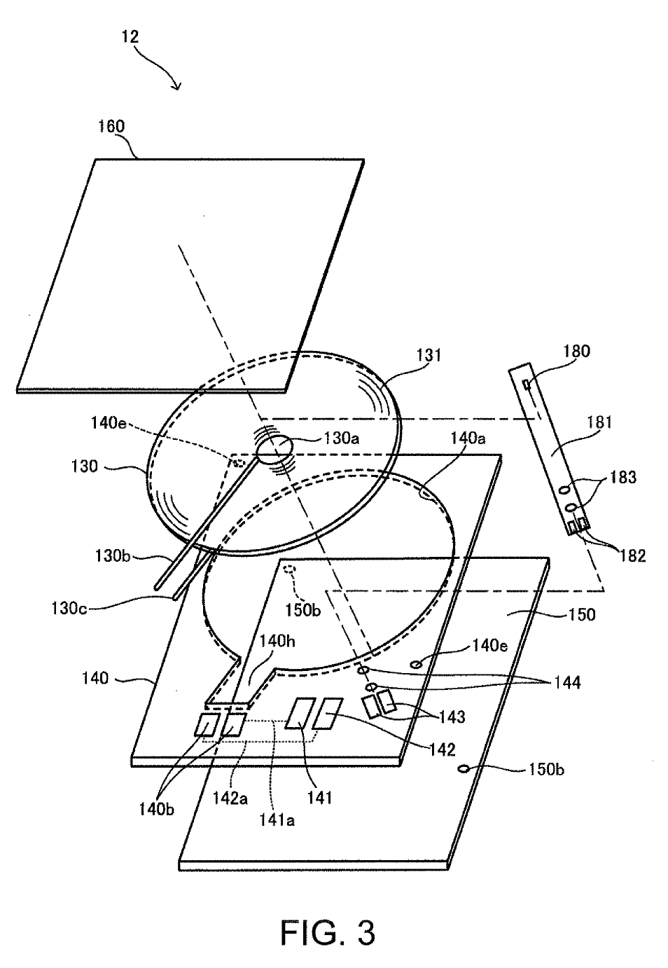

FIG. 3 is an exploded perspective view typically showing the coil unit 12 of the charging device 10. FIG. 3 is a view of coil unit 12 viewed from a non-transmission face which is the opposite side of a transmission face where the coil unit 12 faces the coil unit 22 of the mobile phone 20.

The coil unit 12 includes a flat coil 130 formed by winding a coil wire 131 and a magnetic sheet 160 forming a magnetic path of the flat coil 130.

The coil unit 12 further includes a flexible substrate 181 placed in a plane where the flat coil 130 is placed so as to be in parallel to the flat coil 130, and a temperature detection element, e.g., a thermistor 180 mounted on the flexible substrate 181.

Since the coil unit 12 according to the embodiment is configured so that thin structural elements including the flat coil 130, the magnetic sheet 160 and the flexible substrate 181 are laminated, the coil unit 12 can be formed to be thin. In addition, since the temperature detection element, e.g., the thermistor 180 is placed in the plane where the flat coil 130 is placed, it is possible to detect a degree of rise of temperature by the thermistor 180 when a foreign object enters between the primary coil L1 (130) and the secondary coil L2 shown in FIG. 2.

The flat coil 130 according to the embodiment has an air core part 130a at a center thereof, and is configured so that the coil wire 131 is spirally wound around the air core part on the plane. At that time, the thermistor 180 mounted on the flexible substrate 181 is placed to be positioned on the air core part 130a of the flat coil 130. The details of the thermistor 180 and the flexible substrate 181 are described later.

In the embodiment, in a case where one face of the flat coil 130 is made to be the transmission face and the other face is made to be the non-transmission face, the magnetic sheet 160 is placed to the non-transmission face side of the flat coil 130. At that time, the flexible substrate 181 can be provided between the coil wire 131 and the magnetic sheet 160, i.e., between the non-transmission face of the flat coil 130 and the magnetic sheet 160. With the above configuration, as the flexible substrate 181 is not positioned on the transmission face side of the flat coil 130, a transmission distance between the primary coil L1 (130) and the secondary coil L2 shown in FIG. 2 can be reduced, thereby improving a transmission efficiency.

The coil unit 12 may further have a circuit substrate 140. The circuit substrate 140 is suitable for maintaining a shape of the coil unit 12 and enables the flat coil 130 or the flexible substrate 181 to be electrically connected.

In the embodiment, a coil housing section 140a is formed on the circuit substrate 140, and the coil housing section 140a is formed of, for example, a coil housing hole penetrating through the circuit substrate 140 from the front face to back face. The flat coil 130 is accommodated in the coil housing hole 140a. With the above configuration, all of or a part of the thickness of a spirally wound part of the flat coil 130 is absorbed by the coil housing hole 140a of the circuit substrate 140, thereby reducing the total thickness of the coil unit 12. In addition, the transmission face side of the flat coil 130 is disclosed through the coil housing hole 140a of the circuit substrate 140 so that the transmission distance between the primary coil L1 (130) and the secondary coil L2 can be reduced, thereby improving the transmission efficiency.

A protection sheet 150 for protecting the flat coil 130 and the circuit substrate 140 can be provided to the transmission face side of the circuit substrate 140.

Next, structural components are specifically described below.

There are no particular restrictions on the flat coil 130 as long as it is a flat type coil. For example, an air core coil configured so that a single core or multi-core coated coil wire is wound in a plane, can be used for the flat coil 130. In the embodiment, a multi-core coil wire having a dozen of cores is used.

As the above described, the flat coil 130 is accommodated in the coil housing section 140a provided to the circuit substrate 140. The accommodating of the flat coil 130 to the coil housing section 140a, contributes to reduction of the thickness of the coil unit 12. The transmission face of the flat coil 130 can be readily flush with a peripheral face of the transmission face. In the embodiment, in fact, irregularities are not produced on the protection sheet 150. The coil housing hole 140a is in a shape corresponding to the outer shape of the flat coil 130. With the above configuration, by only accommodating the flat coil 130 to the coil housing hole 140a, the flat coil 130 can be positioned to the circuit substrate 140, thereby facilitating the positioning.

The flat coil 130 has a coil inner end draw wire 130b for drawing an inner end of the coil and a coil outer end draw wire 130c for drawing an outer end of the coil. It is preferable to draw the coil inner end draw wire 130b from the non-transmission face side of the flat coil 130 as shown in FIG. 3. By drawing the coil inner end draw wire 130b from the non-transmission face side, it is possible to prevent a projection of the coil inner end draw wire 130b from being formed on the transmission face so that the transmission face can be flat and the transmission efficiency can be improved.

A draw wire accommodating hole 140h continuous to the coil housing hole 140a is provided to the circuit substrate 140. The draw wire accommodating hole 140h is adapted to accommodate the coil inner end draw wire 130b and the coil outer end draw wire 130c of the flat coil 130. Since the draw wire accommodating hole 140h is formed and the draw wires 130b and the 130c are accommodated in the draw wire accommodating hole 140h, it is possible to reduce the thickness of the above area by the thickness of the draw wires 130b and the 130c. In addition, as the draw wires 130b and 130c are comparatively smoothly curved in the draw wire accommodating hole 140h to be mounted on the circuit substrate 140, breaking of the wire hardly occurs.

The coil inner end draw wire 130b and the coil outer end draw wire 130c are drawn to contact electrodes (coil connection terminals) 140b and are electrically connected to the contact electrodes 140b by soldering. The contact electrodes 140b are provided to the non-transmission face side of the circuit substrate 140 (the front side in FIG. 3).

As shown in FIG. 3, outer connection terminals 141 and 142 are provided to the circuit substrate 140. One outer connection terminal 141 is connected to one contact electrode 140b with a wire 141a provided to the transmission face side of the circuit substrate 140. The other outer connection terminal 142 is connected to the other contact electrode 140b with a wire 142a provided to the transmission face side of the circuit substrate 140. The circuit substrate 140 has provided thereto a plurality of, for example, two positioning holes 140e for positioning the circuit substrate 140 to the protection sheet 150.

The protection sheet 150 is adapted to protect at least the flat coil 130, and the protection sheet 150 covers the entire transmission side faces of the circuit substrate 140 and the flat coil 130 in this embodiment. There are no particular restrictions on the protection sheet 150 as long as it primarily has an insulation property. As shown in FIG. 3, the protection sheet 150 has provided thereto positioning holes 150b at positions corresponding to the positioning holes 140e on the circuit substrate 140. With the positioning holes 140e and 150b, the positioning of the circuit substrate 140 to the protection sheet 150 can be readily carried out.

In addition, the outer shape of the protection sheet 150 is coincident with that of the circuit substrate 140 in the embodiment, but is not limited thereto. The protection sheet 150 can be configured so as to maximize the shape (area) thereof contacting an inner shape (area) of an outer case with which the transmission face side of the coil unit is in contact. With the above configuration, the heat-radiating efficiency can be more improved.

An inner terminal of the flat coil 130 is drawn from the non-transmission face side. With the above configuration, the transmission face is made flat so that a degree of adhesion between the flat coil 130 and the protection sheet (heat-radiating sheet) 150 can be increased and a contact heat resistance can be reduced, thereby improving the heat-radiating efficiency.

The magnetic sheet 160 is attached to the non-transmission face side of the flat coil 130. The magnetic sheet 160 is adapted to receive magnetic fluxes from the flat coil 130 and has a basic function of increasing an inductance of the flat coil 130. As a material of the magnetic sheet, various kinds of materials such as a soft magnetic material, a ferrite soft magnetic material, and a metallic soft magnetic material can be used.

As the magnetic sheet 160 on the charging device 10, a material having a comparatively highly soft material may be used. As a result, even when the coil inner end draw wire 130b of the primary coil 130 or the flexible substrate 181 is projected to the non-transmission face side of the primary coil 130, the magnetic sheet 160 can be deformed by following the projected portion. Accordingly, it is not necessary to interpose a spacer for absorbing a thickness of the coil inner end draw wire 130b or the flexible substrate 181 between the primary coil 130 and the magnetic sheet 160. Note that, since the thickness of the flexible substrate 181 is extremely small, deformation of the magnetic sheet 160 hardly occurs.

### 3. Temperature Detection Element of Primary Coil

In a non-contact power transmission system using the electromagnetic induction action as shown in FIG. 1, when a foreign object made of metal is interposed between the coil unit 12 and the coil unit 22 during the transmission of electric power, an eddy current is generated on the foreign object to generate heat, and then the foreign object and the primary coil 130 may undergo an excessive heat condition. Even when there is not a foreign object, the coil 130 may also undergo an excessive heat condition for some reason.

Therefore, the thermistor 180 of an example of the temperature detection element (temperature detection sensor) is provided to a region (magnetic flux forming region) where the magnetic fluxes are formed by the flat coil 130 in the embodiment. In the embodiment, in particular, the thermistor 180 is disposed in the air core part 130a of the flat coil 130 so as to monitor temperature of the flat coil 130 and the periphery thereof. It is because that the magnetic flux density at the air core part 130a is particularly large. When a foreign object is input to the air core part 130a, the rising of temperature due to eddy current generated on the foreign object is the steepest, and heating is enhanced. With the above configuration, it is possible to surely detect that a foreign object exists on a portion near the air core part 130a by means of the thermistor 180.

When the temperature detected by the thermistor 180 has become not lower than a prescribed level, both of the ambient temperature and the temperature detected by the thermistor 180 have become not lower than a prescribed level, or the rising speed of the temperature has become not lower than a prescribed level, driving of the flat coil 130 in the charging device 10 can be stopped.

The thermistor 180 is placed at the air core part 130a of the flat coil 130 by using a flexible circuit substrate 181. The thermistor 180 is provided to a tip portion of the flexible circuit substrate 181 and an electrode 182 is provided to the other end thereof The flexible circuit substrate 181 is interposed between the flat coil 130 and the magnetic sheet 160, and it is placed at the non-transmission side of the flat coil 130 in a radial direction from the air core part 130a. With the above configuration, the thermistor 181 mounted on the flexible circuit substrate 181 at the one end side is placed at the air core part 130a of the flat coil 130. The electrode 182 of the flexible circuit substrate 181 is connected to an electrode 143 of the circuit substrate 140.

### 4. Primary Coil Unit and Control Unit

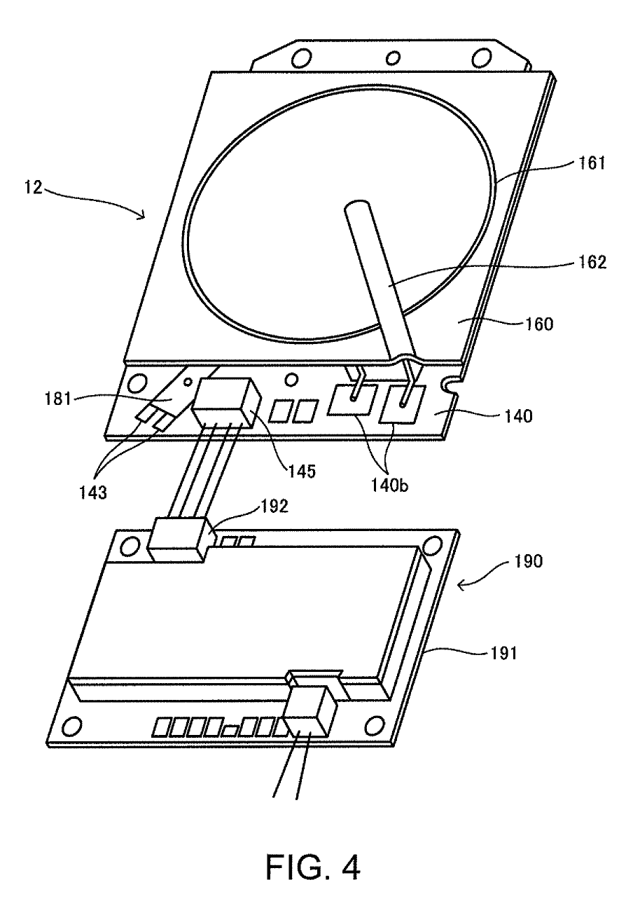

FIG. 4 shows a configuration in which the coil unit 12 and a control unit 190 are electrically connected to each other. A transmission device is configured of the coil unit 12 and the control unit 190. While the basic structure of the coil unit 12 shown in FIG. 4 is the same as that shown in FIG. 3, the arrangement of the coil inner end draw wire 130b, coil outer end draw wire 130c, and the flexible circuit substrate 181 in the coil unit 12 shown in FIG. 4 is different from that shown in FIG. 3.

In the coil unit 12 shown in FIG. 4, the magnetic sheet 160 at the non-transmission face side of the flat coil 130 accommodated in the substrate 140 includes a first deformed part 161 which is deformed along the flat coil 130 protruding from the surface of the substrate 140, and a second deformed part 162 which is deformed along the coil inner end draw wire 130b. The thickness of the flexible circuit substrate 181 is so small that the magnetic sheet 160 is hardly deformed and is able to absorb the thickness of the flexible circuit substrate 181.

The control unit 190 shown in FIG. 4 is formed independent from the coil unit 12. A first connector 145 to be connected to the external connection terminals 141 and 142 (FIG. 3) is mounted on the substrate 140 of the coil unit 12, and a second connector 192 is mounted on a substrate 191 of the control unit 190. By electrically connecting the first and second connectors 145 and 192 to each other, the coil unit 12 and the control unit 190 are electrically connected to each other.

Various circuits for driving the coil unit 12 are mounted on the control unit 190. For example, the control unit 190 includes a power transmission circuit for performing non-contact power transmission by energizing the primary coil 130. A power transmission control section is provided to the power transmission circuit. The power transmission control circuit can cut the energizing of the primary coil 130 in accordance with a signal received from the thermistor 180 of the coil unit 12 when abnormal temperature is detected.

### 5. Transmission Device

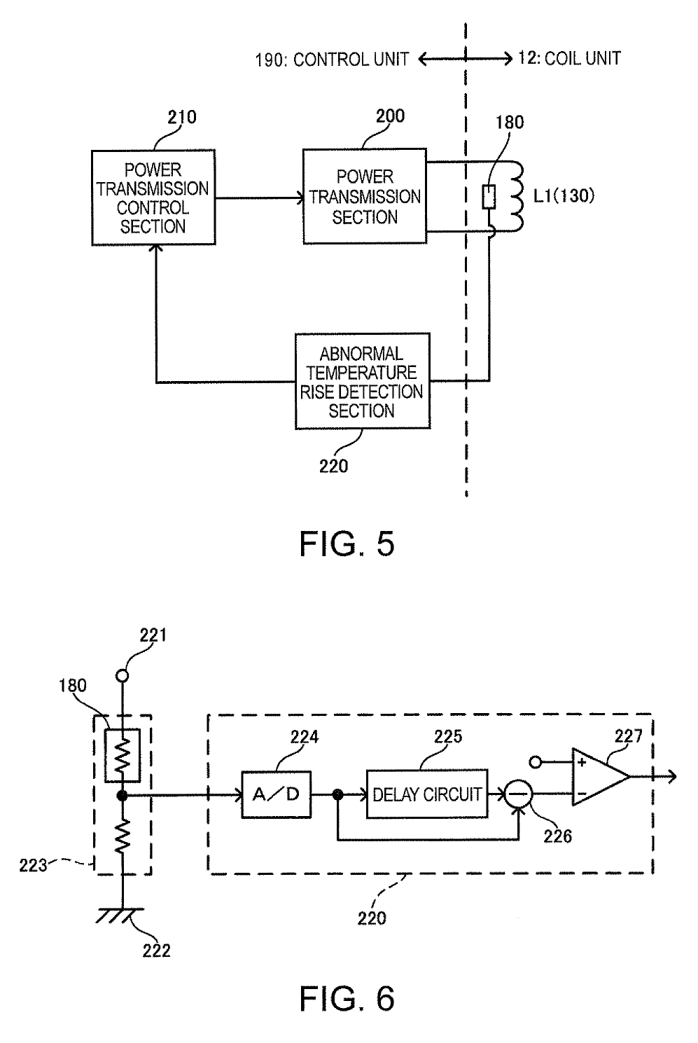

FIG. 5 is a schematic block diagram of a transmission device including the coil unit 12 shown in FIG. 3 and the control unit 190 shown in FIG. 4. As shown in FIG. 5, in the transmission device, the control unit 190 includes a power transmission section 200, a power transmission control section 210 and an abnormal temperature rise detection section 220.

The power transmission section 200 generates an AC voltage in a prescribed frequency while transmitting electric power and generates an AC voltage in a frequency varied corresponding to data while transmitting the data, and supplies them to the primary coil L1 (130). The power transmission section 200 may include a first power transmission driver for driving one end of the primary coil L1, a second power transmission driver for driving the other end of the primary coil L1, and at least one capacitor forming a resonance circuit together with the primary coil L1.

Each of the first and second power transmission drivers provided in the power transmission section 200 is an inverter circuit (buffer circuit) configured of, for example, a power MOS transistor and is controlled by the power transmission control section 210. A control process of the power transmission control section 210 includes a control process of stopping the transmission of electric power by stopping the energizing of the primary coil L1 in accordance with a signal from the abnormal temperature rise detection section 220.

FIG. 6 is a block diagram showing an exemplary structure of the abnormal temperature rise detection section 220 shown in FIG. 5. As shown in FIG. 6, a voltage dividing circuit 223 including the thermistor 180 is provided between a high voltage wire 221 and a low voltage wire 222. An analogue voltage divided by the voltage dividing circuit 223 is input to an analogue-digital (A/D) converter 224. The A/D converter 224 converts the divided voltage to a digital signal. A delay circuit 225 delays the digital signal from the AID converter 224. A subtractor 226 computes a difference between a signal at a first clock time from the delay circuit 225 and a signal at a second clock from the N/D converter 224.

In the embodiment, the signal (second voltage) at the second clock time from the AID converter 224 is subtracted from the signal (first voltage) at the first clock time from the delay circuit 225. When an output from the subtractor 226 is positive, it means that the thermistor 180 detects the temperature in the rising. When the output from the subtractor 226 is negative, it means that the thermistor 180 detects the temperature in the falling.

A comparator 227 compares the output of the subtractor 226 with a reference value Ref. As the reference value Ref, a value of temperature at abnormal rising of temperature per a time period (unit time) delayed by the delay circuit 225 is preset. Therefore, when a comparison output of the comparator 226 is positive (in the rising of temperature) and a temperature rise value per the unit time is not lower than the reference value Ref, the comparator 227 outputs a signal of e.g., an H level. In a case different from the above, the comparator 227 outputs a signal of e.g., an L level.

That is, the abnormal temperature rise detection section 220 shown in FIG. 6 can detects abnormal temperature rise in accordance with a voltage at a first clock time and a second voltage at a second clock time which are varied by a variable resistance of the thermistor 180.

The output of the abnormal temperature rise detection section 220, i.e., the output of the comparator 227 is input to the power transmission control section 210. When the output of the comparator 227 is in the H level, the power transmission control section 210 controls to stop the transmission of electric power. When the output of the comparator 227 is in the L level, the power transmission control section 210 controls to continue the transmission of electric power.

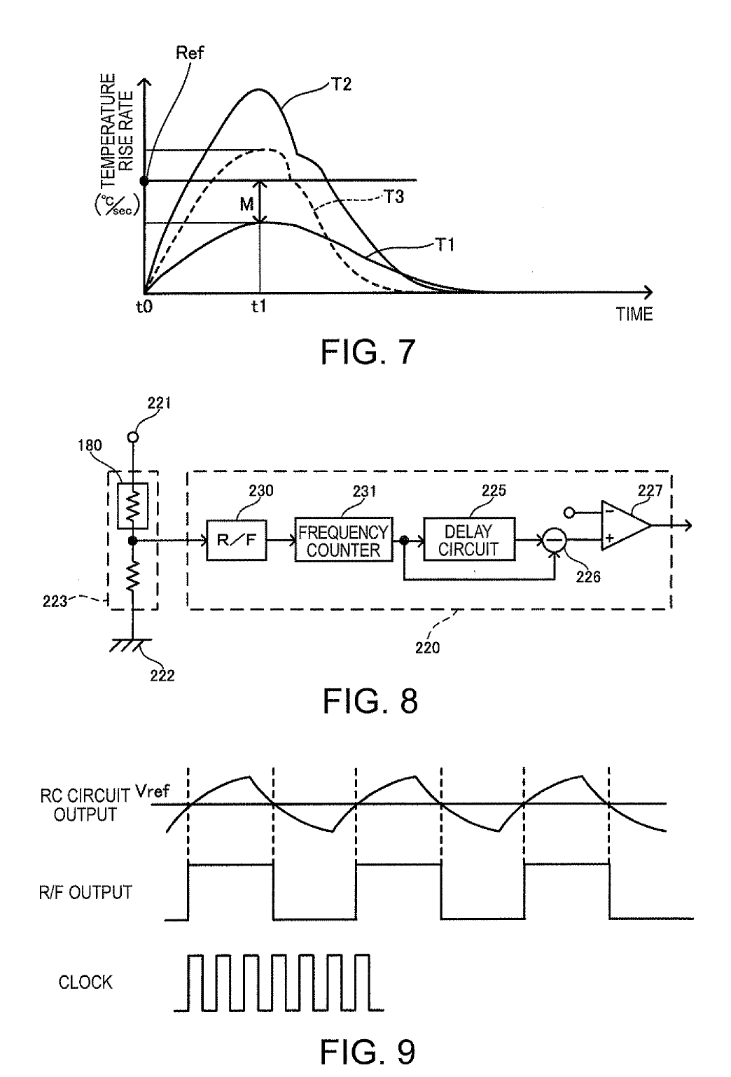

FIG. 7 is a characteristic graph showing a temperature rising curve from start of the transmission of electric power. As shown in FIG. 7, the temperature detected by the thermistor 180 is varied along a curve T1 by virtue of heat of the primary coil L1 due to energizing in a normal condition. That is, the temperature rises from start of the transmission of electric power. The temperature rise rate becomes a maximum at clock time t1. After that, the temperature rise rate is decreased. When the temperature reaches its saturation level, the temperature rise rate becomes zero.

In FIG. 7, a curve T2 is a temperature rising curve in a case where a foreign object exists on the air core part 130a of the primary coil L1 between the primary and secondary coils L1 and L2, and a curve T3 is a temperature rising curve in a case where a foreign object exists at a portion out of the air core part 130a. While the temperature rise rate of the rising curve T2 is greater than that of the rising curve T3 after starting the transmission of electric power, both of the temperature rise rates of the rising curves T2 and T3 in an abnormal condition after starting the transmission of electric power are greater than that of the curve T1 in a normal condition.

As a result, in a case where a threshold value which can give a prescribed margin M between the rising curve T1 in a normal condition and the rising curve T3 in an abnormal condition is set to the comparator 227 shown in FIG. 6 as the reference value Ref, it is possible to judge that abnormal condition occurs when the temperature rise rate becomes greater than the threshold value.

In the embodiment, temperature is detected by the thermistor 180 every 0.2 second in a case that a current of the coil is, for example, 2 mA. A temperature difference between a first temperature value at a time before the unit time, e.g., 10 second (first clock time) and a second temperature value at a present time (second clock time) is compared with the threshold value. With the above process, the transmission of electric power can be stopped in an abnormal condition. In particular, as the rising speed of the temperature is checked, it is possible to stop the transmission of electric power by detecting the abnormal condition before the temperature reaches a certain absolute value (a danger temperature).

However, since the temperature rise rate and the margin M between normal and abnormal conditions are varied depending on a heat radiating environment such as a peripheral member of the primary side coil unit 12, e.g., a material, a thickness or a shape of a primary side housing, or a distance between the coil unit 12 and the housing, it is preferable to adjust the reference value of the comparator 227 for each product or at each shipment time.

FIG. 8 is a block diagram showing another exemplary structure of the abnormal temperature rise detection section 220 shown in FIG. 5. In the abnormal temperature rise detection section 220 shown in FIG. 8, the AID converter 224 shown in FIG. 6 is replaced with a resistance-frequency (R/F) converter 230 and a frequency counter 231. The R/F converter 230 functions to convert the resistance value of the thermistor 180 to a frequency, and forms an RC circuit together with the resister of the thermistor 180.

FIG. 9 is a diagram showing an output signal of the R/F converter 230. The R/F converter 230A converts a signal varied depending on a time constant of the RC circuit to a rectangular wave by comparing it with a given threshold value Vref. As shown in FIG. 9, a frequency counter 231 counts the output signal of the R/F converter 230 by using a clock signal.

Here, when the thermistor 180 has, for example, a negative characteristic in which its resistance value is decreased as rising of the temperature, the time constant of the RC circuit is decreased as rising of the temperature so that the frequency becomes higher. At low temperature, the time constant of the RC circuit is increased so that the frequency becomes lower. Thus, since the frequency is correlated to the temperature, it is possible to detect the rising of temperature in an abnormal condition in a similar manner to the case that the temperature rise rate is detected based on the voltage value correlated to the temperature as shown in FIG. 6. Namely, the abnormal temperature rise detection section 220 in FIG. 8 can detect abnormal rising of temperature based on a comparison result obtained by comparing a first frequency at a first clock time and a second frequency at a second clock time with each other, the frequency being varied depending on the variable resistance value of the thermistor 180.

### 6. Modified Embodiment

While the embodiment of the invention is described in detail as the above, it will be readily understood by a person skilled in the art that numerous modifications or changes can be made without departing from the spirit or scope of the invention. Therefore, these modifications or changes are included within the scope of the invention. For example, a word which is used at least one time in the descriptions or drawings and is described together with a different wide or synonymous word can be replaced with the different word at any portion in the descriptions or drawings.

The above described embodiment is for the case where the embodiment is applied to the coil unit 12 in the mobile phone that particularly requires reduction in size or weight in the electronic apparatuses as shown in FIG. 1. However, the embodiment can be applied to the coil unit 22 of the charging device 10.

In addition, the embodiment can be applied to any electronic apparatus that performs transmission of electric power or signals. The electronic apparatuses include a device to be charged having a rechargeable battery or a charging device such as a wrist watch, an electric toothbrush, an electric shaver, a codeless phone, a personal handy phone, a mobile personal computer, a PDA (Personal Digital Assistant), or an electric bicycle.

Further, in addition, the coil unit in the invention is not limited to a flat coil having a wire spirally wound around an air core, and variety of coils can be used.

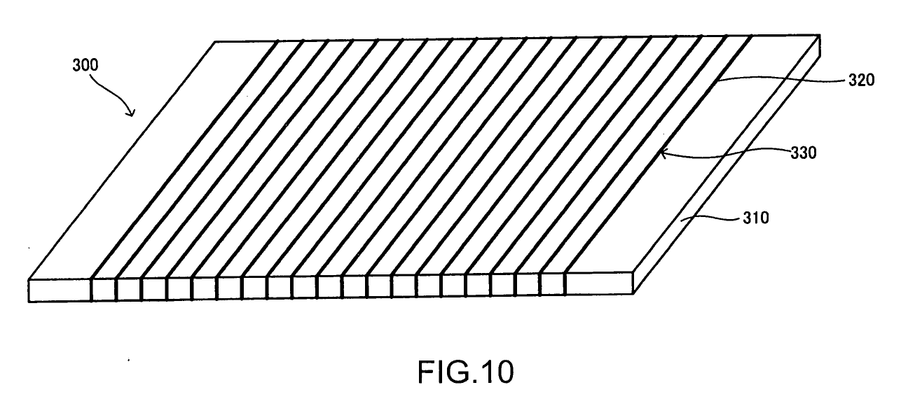

FIG. 10 shows a coil unit 300 in a type different from that of the above described embodiment. The coil unit 300 has a coil 330 configured so that a coil wire 320 is wound around, for example, a plate type magnetic core 310. When an AC current is applied to the coil wire 320 of the coil unit 300, a magnetic path is formed on the magnetic core 310 and magnetic fluxes are formed in parallel to the magnetic core 310. By using the coil unit 300 as the primary coil L1, the transmission of power in a non-contact manner can be carried out by means of electromagnetic coupling with the secondary coil L2.

Namely, the invention can be applied to not only a unit having a magnetic material at one face of a coil but also a unit having a magnetic material as a core. A combination of a coil and a magnetic material forming a magnetic path of the coil is not limited to the above described one, a combination of a coil and a magnetic material in various shapes can be used. The coil unit is not limited to a flat type thin coil unit. There are no restrictions on a kind of the coil as long as an abnormal condition can be detected based on a rate of temperature rising due to heat of a foreign object interposed between the primary and secondary coils L1 and L2.

1. A non-contact power transmission device to supply electric power to a secondary coil from a primary coil by electromagnetically coupling the primary coil to the secondary coil, comprising:
a temperature detection element that detects temperature; and
a detection section that detects a rise of temperature based on a first temperature detected by the temperature detection element at a first time and a second temperature detected by the temperature detection element at a second time,
the non-contact power transmission device stopping supplying electric power from the primary coil when the detection section detects that the rise of temperature is greater than a reference value.

2. The non-contact power transmission device according to claim 1,
the temperature detection element being a variable resistance element with a resistance value that varies with temperature.

3. The non-contact power transmission device according to claim 2,
the detection section detecting the rise of temperature based on a first voltage across the variable resistance element at the first time and a second voltage across the variable resistance element at the second time.

4. The non-contact power transmission device according to claim 2,
the detection section including a resistance-frequency conversion circuit that converts the resistance value of the variable resistance element to a frequency, the detection section detecting the rise of temperature based on a result obtained by comparing a first frequency at the first time with a second frequency at the second time.

5. The non-contact power transmission device according to claim 3,
the detection section including a comparator that compares a the rise of temperature with the reference value, and the reference value being adjustable.

6. A power transmission device that supplies electric power to a power reception device by electromagnetically coupling a primary coil to a secondary coil, the power transmission device comprising:
a power transmission section that transmits an alternating current (AC) signal to the primary coil;
a temperature detection element disposed in a magnetic flux forming region of the primary coil;
a detection section that detects a rise of temperature based on a first temperature detected by the temperature detection element at a first time and a second temperature detected by the temperature detection element at a second time; and
a power transmission control section that controls the power transmission section,
the power transmission control section stopping transmission of electric power from the primary coil when the detection section detects that the rise of temperature is greater than a reference value.

7. The power transmission device according to claim 6,
the temperature detection element being a variable resistance element with a resistance value that varies with temperature.

8. The power transmission device according to claim 7,
the detection section detecting the rise of temperature based on a first voltage across the variable resistance element at the first time and a second voltage across the variable resistance element at the second time.

9. The power transmission device according to claim 7,
the detection section including a resistance-frequency conversion circuit that converts the resistance value of the variable resistance element to a frequency, and that detects the rise of temperature based on a result obtained by comparing a first frequency at the first time with a second frequency at the second time.

10. The power transmission device according to claim 8,
the detection section including a comparator that compares the rise of temperature with the reference value, and the reference value being adjustable.

11. The power transmission device according to claim 6, the primary coil being an air core coil having an air core part, and the temperature detection element being provided to the air core part.

12. An electronic apparatus, comprising: the non-contact power transmission device according to claim 1.

13. An electronic apparatus, comprising the non-contact power transmission device according to claim 6.

14. A method of detecting an abnormal condition in a non-contact power transmission device that supplies electric power to a power reception device by electromagnetically coupling a primary coil of the non-contact power transmission device to a secondary coil of the power reception device, the method comprising:
generating a first value that corresponds to a first temperature within the non-contact power transmission device at a first time;
generating a second value that corresponds to a second temperature within the non-contact power transmission device at a second time;
determining a rise of temperature based on a comparison of the first value with the second value; and
disconnecting power to the primary coil of the non-contact power transmission device in the case where the rise of temperature is greater than a reference value.

15. The method of claim 14, the determining the rise of temperature comprising:
generating a rise of temperature based on the first value and the second value.

16. The method of claim 15, the disconnecting power to the primary coil of the non-contact power transmission device being performed based on a comparison result of the rise of temperature to the reference value.

17. The method of claim 14, the determining the rise of temperature comprising:
generating a first frequency based on the first value;
generating a second frequency based on the second value; and
generating a rise of temperature based on a count of the first frequency and a count of the second frequency.

18. The method of claim 17,
the disconnecting power to the primary coil of the non-contact power transmission device being performed based on a comparison result of the rise of temperature to the reference value.
